(19) United States
(12) Patent Application Publication
(10) Pub. No.: US 2008/0118142 A1
(43) Pub. Date: May 22, 2008

(54) MONITORING SYSTEM FOR MANUFACTURING SEMICONDUCTOR WAFERS

(76) Inventor: Po-Chun Chang, Sindian City (TW)

Correspondence Address: PAI PATENT & TRADEMARK LAW FIRM, 1001 FOURTH AVENUE, SUITE 3200, SEATTLE, WA, 98154, US

(21) Appl. No.: 11/682,892

(22) Filed: Mar. 7, 2007

(30) Foreign Application Priority Data
Nov. 20, 2006 (TW) 95142872

(51) Int. Cl. G06K 9/00

(52) U.S. Cl. 382/144

(57) ABSTRACT

A monitoring system for manufacturing semiconductor wafers is described. The monitoring system includes a first monitoring picture and a second monitoring picture to display manufacture information of a semiconductor manufacture apparatus for the supervisor to judge the efficiency of the apparatus. The first monitoring picture includes a plurality of bars. Each of the bars shows the working time of one wafer lot. The starting point of the bar is the starting manufacture time of the wafer lot and the ending point is the ending manufacture time thereof. The second monitoring picture further includes a plurality of time block to show the status of the apparatus. The starting points of the blocks are the starting time of the status and the ending points are the ending time thereof. The first monitoring picture further includes a plurality of controlling periods.

### RELATED APPLICATIONS

This application claims priority to Taiwan Application Serial Number 95142872, filed Nov. 20, 2006, which is herein incorporated by reference.

### FIELD OF THE INVENTION

The present invention generally relates to a monitoring system for manufacturing semiconductor wafers. More particularly, this invention relates to a monitoring picture of a monitoring system for manufacturing semiconductor wafers.

### BACKGROUND OF THE INVENTION

Since the semiconductor industry is highly developed, electronic products are becoming increasingly light and the functionalities thereof are increasingly powerful. Nowadays, semiconductor ICs are produced by a plurality of precise manufacturing processes to define the circuits and elements on the wafer.

The precise manufacturing processes are achieved on a lot of manufacturing equipment with numerous manufacturing controls. Therefore, to effectively control the manufacturing of semiconductors, the semiconductor manufacturing equipment providers equipment continuously endeavor to work on novel controlling methods and systems to increase the semiconductor product manufacturing yield rates, improve the quality and reliability of the semiconductor products, and reduce the manufacturing cost thereof.

Some of providers of the semiconductor manufacturing equipment utilize hardware and software to monitor the manufacturing processes to guarantee the stability, reproducibility and yield rate of the manufacturing processes. In addition, additional inspections imposed on the semiconductor wafers further increase the accuracy of the process control manufacturing process control.

Most of the hardware and software for monitoring the manufacturing processes provides partial process control ability and records detailed production information data and test data with a computer, the production supervisor still cannot effectively determine the actual status with the raw data recorded in the computer without suitable information to show the actual status of the manufacturing process. Therefore, there is a need to provide suitable information that can effectively show the desired manufacturing data on the display to enable the production supervisor to determine the actual status of the manufacturing process and the bottleneck of the manufacturing process so as to improve the manufacturing yield rate and efficiency of semiconductor manufacture.

### SUMMARY OF THE INVENTION

It is an objective of the present invention to provide a monitoring system for manufacturing semiconductor wafers with a first monitoring picture and a second monitoring picture to effectively determine the status of and bottlenecks in the manufacturing processes.

It is another objective of the present invention to provide dynamic computer pictures with a predetermined configuration to show the manufacturing status on a display so as to easily control the manufacturing of semiconductors.

To accomplish the above objectives, the present invention provides a monitoring system for manufacturing semiconductor wafers. The monitoring system includes a first monitoring picture and a second monitoring picture. The first monitoring picture includes a first coordinate and a second coordinate perpendicular to each other. The first coordinate is a time coordinate and the second coordinate is a change record. The second monitoring picture includes a third coordinate and a fourth coordinate perpendicular to each other. The third coordinate is a time coordinate and the fourth coordinate shows block descriptions thereon. The first monitoring picture further includes a plurality of bars illustrated thereon. Each bar represents the working time of one wafer lot processed in the manufacturing equipment, and one end, preferably the left end, of the bar is the starting manufacture time and the other end, preferably the right end, of the bar is the ending manufacture time of the wafer lot processed in the manufacturing equipment. The second monitoring picture further includes a plurality of time blocks illustrated thereon. Each time block represents an event status of the manufacturing equipment, and one end of the time block is the starting time of the event status of the manufacturing equipment and the other end of the time block is the ending time of the event status of the manufacturing equipment.

The change record is a photo mask change record, such as the serial numbers of photo mask used in the manufacturing equipment. Alternatively, the change record can be a mold change record and/or a jig change record. The time block is a setup time block, an idle time block, a monitor time block and/or a wait time block.

The first monitoring picture preferably includes a plurality of controlling periods, e.g. a shift change period, an eating period and/or a night shift period, illustrated thereon.

Another aspect of the present invention is to provide a computer display for monitoring semiconductor manufacturing equipment. The computer display includes a first monitoring picture and a second monitoring picture. The first monitoring picture further includes a plurality of bars illustrated thereon. Each bar represents the working time of one wafer lot processed in the semiconductor manufacturing equipment, and one end, preferably the left end, of the bar is the starting manufacture time and the other end, preferably the right end, of the bar is the ending manufacture time of the wafer lot processed in the semiconductor manufacturing equipment. The second monitoring picture further includes a plurality of time blocks illustrated thereon. Each time block represents an event status of the semiconductor manufacturing equipment, and one end of the time block is the starting time of the event status of the semiconductor manufacturing equipment and the other end of the time block is the ending time of the event status of the semiconductor manufacturing equipment. The first monitoring picture preferably includes a plurality of controlling periods, e.g. a shift change period, an eating period and/or a night shift period, illustrated thereon.

Accordingly, the production supervisor utilizing the monitoring system for manufacturing semiconductor wafers according to the present invention with the first monitoring picture and the second monitoring picture can easily control the manufacturing equipment of the manufacturing processes and determine if there are any bottlenecks in the manufacturing equipment so as to improve the manufacturing efficiency of the semiconductor products, increase the yield rate of the production line and reduce the rework ratio in the factory.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a first embodiment of a monitoring system for manufacturing semiconductor wafers according to the present invention;

FIG. 2 illustrates a second embodiment of a monitoring system for manufacturing semiconductor wafers according to the present invention;

FIG. 3 illustrates a third embodiment of a monitoring system for manufacturing semiconductor wafers according to the present invention;

FIG. 4 illustrates a run chart showing ratios of all the manufacturing steps to the bottleneck equipment of factory;

FIG. 5 illustrates a run chart showing ratios of all the manufacturing steps to the bottleneck equipment of the factory; and

FIG. 6 illustrates a run chart showing rework ratios of the factory utilizing the monitoring system for manufacturing semiconductor wafers according to the present application.

### DETAILED DESCRIPTION OF THE PREFERRED EMBODIMENT

The following description is currently the best implementation of the present invention. This description is not to be taken in a limiting sense but is made merely to describe the general principles of the invention. The scope of the invention should be determined by referencing the appended claims.

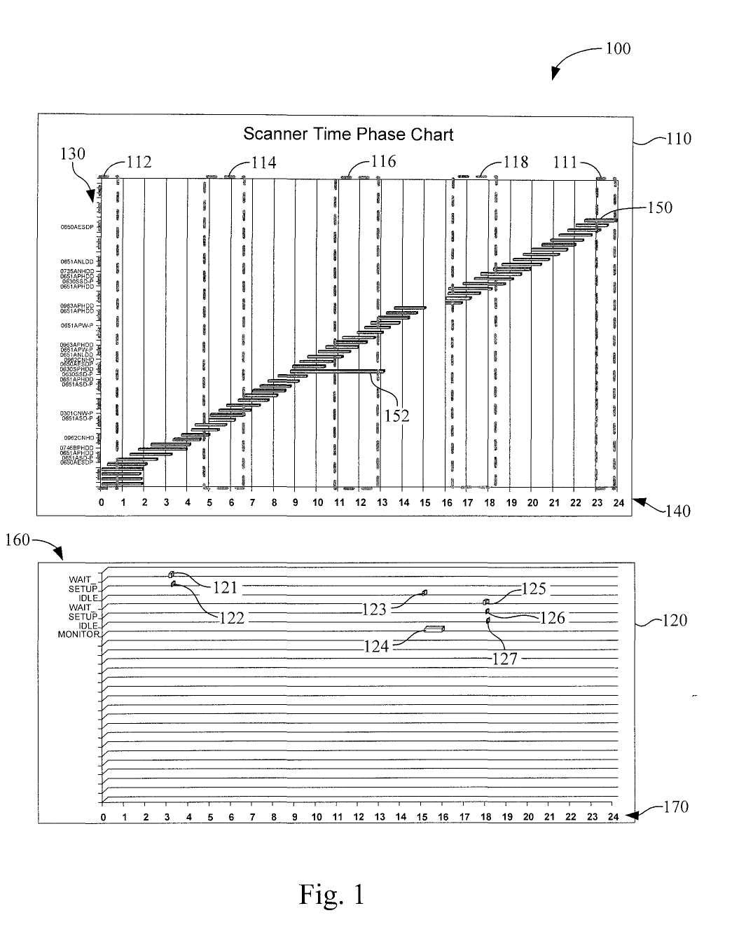

FIG. 1 illustrates a first embodiment of a monitoring system for manufacturing semiconductor wafers according to the present invention. The monitoring system for manufacturing semiconductor wafers 100 includes a first monitoring picture 110 and a second monitoring picture 120, and preferably, the first monitoring picture 110 is disposed above the second monitoring picture 120 and the horizontal coordinates correspond with each other. The horizontal coordinate of the first monitoring picture 110 is preferably a time coordinate 140 and the vertical coordinate is preferably a change record 130. In this embodiment, the change record 130 is preferably a change record for a photo scanner, for example, a photo mask change record such as a change record of photo mask serial numbers. In another embodiment, the change record 130 can be a change record of any tooling, fixtures or jigs in the manufacturing processes. In this embodiment, the horizontal coordinate is a time coordinate 140 and denotes the working time of the photo scanner and the whole range of the time coordinates 140 can be one working day, twenty four hours, a week, a month, a year or the entire working time of the photo scanner.

The first monitoring picture 110 further includes a plurality of bars 150 to respectively represent the starting manufacture time and ending time of one wafer lot processed on the photo scanner. A left endpoint of each of the bars 150 represents the starting manufacture time of the wafer lot processed on the scanner, and the right endpoint of each of the bars 150 represents the ending manufacture time thereof. Accordingly, a plurality of bars 150 are shown on the first monitoring picture 110 with the records of every lot of wafers processed on the photo scanner. In addition, the vertical coordinate represents the change record of the photo mask, and the serial number of the same photo mask can only be shown on the first lot of wafers, which are produced by the same photo mask.

The production supervisor of the semiconductor factory can easily determine the status of every photo mask working on the photo scanner through the bars 150 on the first monitoring picture 110. The production supervisor can also easily determine whether the change frequency of the photo mask is too high and whether the same photo mask is continuously operated. The slope of the bars 150 can also be shown whether the photo scanner is working smoothly, and whether the working efficiency of the photo scanner can reach the target efficiency. That is to say, a sharp slope of the bars 150 means that the photo scanner is working smoothly and every wafer lot can be completely processed on the photo scanner soon. A flat slope of the bars 150 means some wafer lots are processed on the photo scanner over a longer period of time. In general, every wafer lot processed on the photo scanner is proportional to the wafer per hour (WPH) and normally every wafer lot has a similar quantity. If the quantities of some lots of the wafers are different, the actual status of the wafers processed on the photo scanner can be determined by the actual value of the WPH. The actual WPH value can be shown on the first monitoring picture 110, the second monitoring picture 120 or any other place on the display.

For example, when the supervisor finds an exceptional bar 152 with an exceptional length compared with other bars 150, the supervisor can determine the actual status of this wafer lot according to whether the WPH value of this lot is too low or normal. If the WPH value is too low, there is something wrong in the manufacturing process of this wafer lot. If the WPH value is normal, the quantity of this wafer lot is larger than a normal lot.

To effectively distinguish if the manufacturing equipment is operating normal or not, the second monitoring picture 120 provides the desired information for the supervisor to distinguish the status of the manufacturing equipment. The second monitoring picture 120 records the time blocks of events that stop production on the manufacturing equipment. The horizontal coordinate of the second monitoring picture 120 is similar to that of the first monitoring picture 110 is a time coordinate 170, and the vertical coordinate thereof records a block description 160. For example, while a gap is found in the first monitoring picture 110 between 15h00 hours to 16h00 hours, the supervisor can determine the status of the manufacturing equipment with the second monitoring picture with an idle time block 123 and a monitor time block 124. The idle time block 123 and the monitor time block 124 mean that the manufacturing equipment is at first idle for a short period to complete the wafers thereon and then run a test process thereon. If the idle time block 123 and the monitor time block 124 are standard processes to produce next wafer lot, the idle time block 123 and the monitor time block 124 can be ignored by the supervisor.

Similarly, referring to a wait time block 121 and a setup time block 122, the manufacturing equipment waits and then setups around 3h00 hours. Around 18h00 hours, the manufacturing equipment waits, setups and then idles, referring to a wait time block 125, a setup time block 126 and an idle time block 127. The supervisor can easily determine the status of the manufacturing equipment through the second monitoring picture 120 and understand the root causes of the stopping events of the manufacturing equipment, which maybe caused by the manufacturing equipment itself or for some other reason.

In addition, the first monitoring picture 110 can further include a plurality of controlling periods, for example, a first special controlling period 111, a fifth special controlling period 112, a second special controlling period 114, a third special controlling period 116 and/or a fourth special controlling period 118. The first special controlling period 111 is disposed at the end portion of the first monitoring picture 110 to combine with the fifth special controlling period 112 of the next day and the fifth special controlling period 112 is disposed at the start portion of the first monitoring picture 110 to combine with the first special controlling period 112 of the previous day. The controlling periods can be change shift periods, night shift periods or eating periods. The controlling periods are shown on the first monitoring picture 110 with a plurality of blocks encircled with dotted lines so as to be easily observed by the supervisor of the manufacturing equipment so as to easily determine the working status of the manufacturing equipment. For example, in these periods, any manufacturing equipment is stopped for exceptionally long periods and/or the lengths of the bars 150 are exceptionally long. The first monitoring picture 110 and the second monitoring picture 120 are preferably shown on a computer display so that the supervisor can easily understand the status of the manufacturing equipment and the wafers processed thereon.

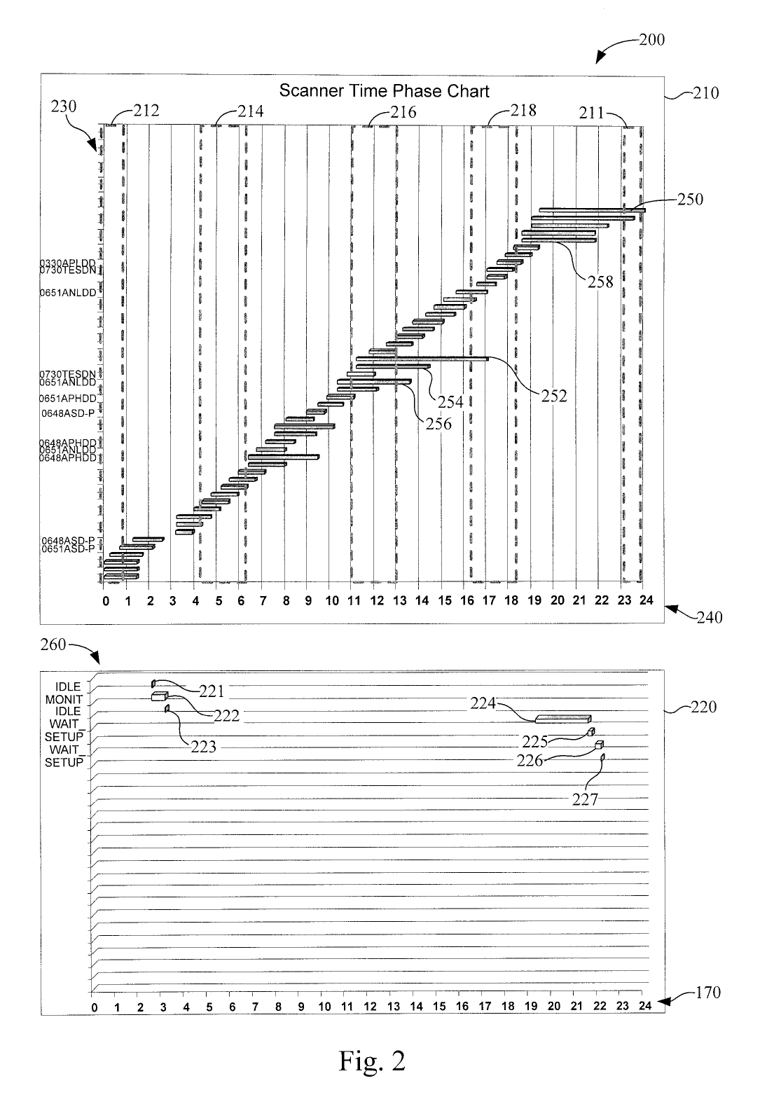

Referring to FIG. 2, a second embodiment of a monitoring system for manufacturing semiconductor wafers according to the present invention is illustrated. The monitoring system for manufacturing semiconductor wafers 200 includes a first monitoring picture 210 and a second monitoring picture 220. Preferably, the first monitoring picture 210 is disposed above the second monitoring picture 220 and the horizontal coordinates thereof correspond with each other. The horizontal coordinate of the first monitoring picture 210 is preferably a time coordinate 240 and the vertical coordinate is preferably a change record 230 such as the photo mask change record 230. Similar to the embodiment of FIG. 1, the change record 230 is preferably a change record for a photo scanner, and therefore the photo mask change record 230 is, for example, a change record of the photo mask serial numbers. The horizontal coordinate is the time coordinate 240 denoting the working time of the photo scanner.

The first monitoring picture 210 utilizes bars 250 to respectively represent the starting manufacturing time and the ending manufacture time of every wafer lot processed on the photo scanner. A WPH value can also be shown on the first monitoring picture 210, the second monitoring picture 220 or any other place on the display. Particularly focusing on the exceptional bars 252/254/256, the lengths thereof are longer than the other bars 250. According to the indication of the exceptional bars 252/254/256, the supervisor can check the WPH value of these lots. If the WPH value is too low, there is something wrong in the manufacturing process of this wafer lot. If the WPH value is normal, it means that the quantity of the wafer lot is larger than a normal lot. In addition, the exceptional bars 252/254/256 all overlap with the third special controlling period 216, 11h00 hours to 13h00 hours. Therefore, if the WPH value is too low, the supervisor should check that there is sufficient manpower or that the employees are not on a scheduled lunchtime. In addition, from the exceptional bar 258 to the end lot of the first monitoring picture 210, all these lots are longer than a normal lot. Therefore, the supervisor should check whether the manpower is sufficient during the night shift. Especially, in the first special controlling period 211, 23h00 hours to 24h00 hours, only two lots of wafers are processed in the photo scanner. Accordingly, the supervisor can easily find the root course of the manufacture delay in the photo scanner and solve the problems.

Referring to the second monitoring picture 220, the second monitoring picture 220 records the exceptional time blocks, such as the idle time block 221, the monitor time block 222, the idle time block 223, the wait time block 224, the setup time block 225, the wait time block 226 and the setup time block 227, of the photo scanner. According to the indication of the wait time block 224, the supervisor should further check the root cause of manufacturing delays in the night shift. According to the indication of the idle time block 221, the monitor time block 222 and the idle time block 223, the supervisor can determine the reason why there is no output at around 3h00 hours.

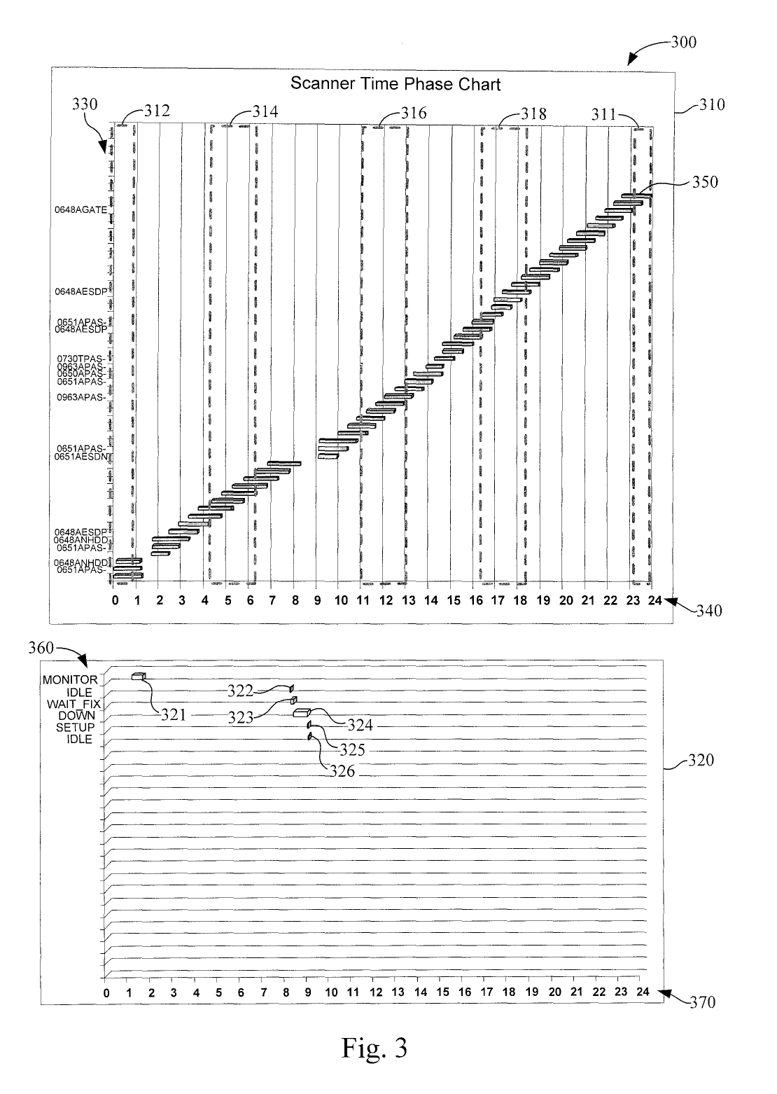

Referring to FIG. 3, a third embodiment of a monitoring system for manufacturing semiconductor wafers according to the present invention is illustrated. The monitoring system for manufacturing semiconductor wafers 300 also includes a first monitoring picture 310 and a second monitoring picture 320. The horizontal coordinate of the first monitoring picture 310 is preferably a time coordinate 340, and the vertical coordinate thereof is preferably a photo mask change record 330.

Similarly to FIGS. 1 and 2, this embodiment illustrates the manufacturing information of a photo scanner. Therefore, the vertical coordinate is a photo mask change record 330 and the horizontal coordinate is a time coordinate 340.

The first monitoring picture 310 utilizes bars 350 to respectively represent the starting manufacture time and ending manufacture time of every wafer lot processed on the photo scanner. A WPH value can also be shown on the first monitoring picture 310, the second monitoring picture 320 or any other place on the display.

In this embodiment, the lengths of the bars 350 are almost the same. It means that every wafer lot processed on the photo scanner has almost the same working time. In addition, the monitor time block 321, at about 1h00 hours to 2h00 hours, informs the supervisor that the photo scanner stops producing semiconductor productions and runs a test process thereon. At around 8h00 hours to −9h00 hours the photo scanner stops again and the second monitoring picture 320 shows an idle time block 322, a wait time block 323, a down time block 324, a setup time block 325 and an idle time block 326. In addition, the photo scanner can smoothly be operated at the other working times.

The first monitoring picture and the second monitoring picture of the monitoring system for manufacturing semiconductor wafers according to the present invention can instantly provide manufacturing information of the manufacturing equipment and the wafers processed on the manufacturing equipment to the supervisor. In addition, the second monitoring picture can further provide the information of delayed events with time blocks to the supervisor so that the supervisor can easily determine the actual root causes of the production delay. Furthermore, in combination with the controlling periods marked on the first monitoring picture, the supervisor can quickly determine the manufacturing status of the manufacturing equipment in these desired controlling periods. Accordingly, the monitoring system according to the present invention can effectively improve the manufacturing efficiency and the supervisor of the manufacturing equipment can easily determine the working efficiency of the manufacturing equipment. In addition, the first monitoring picture and the second monitoring picture can also be disposed horizontally while the time coordinate is the vertical coordinate.

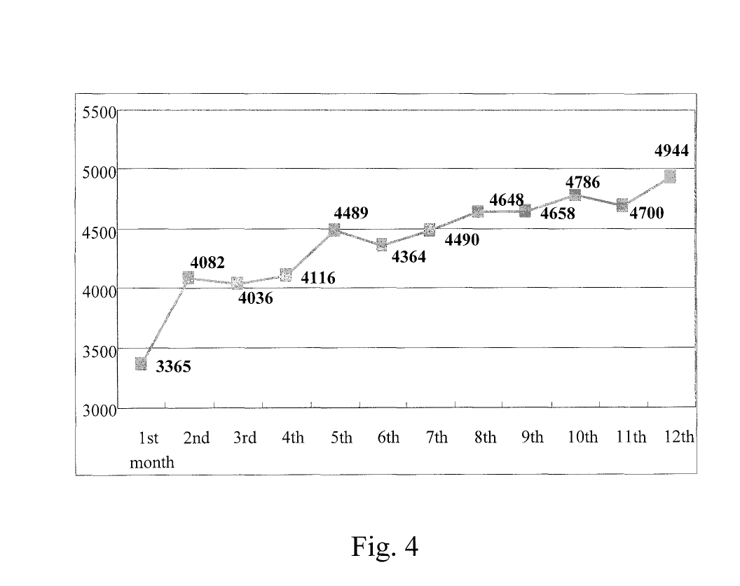

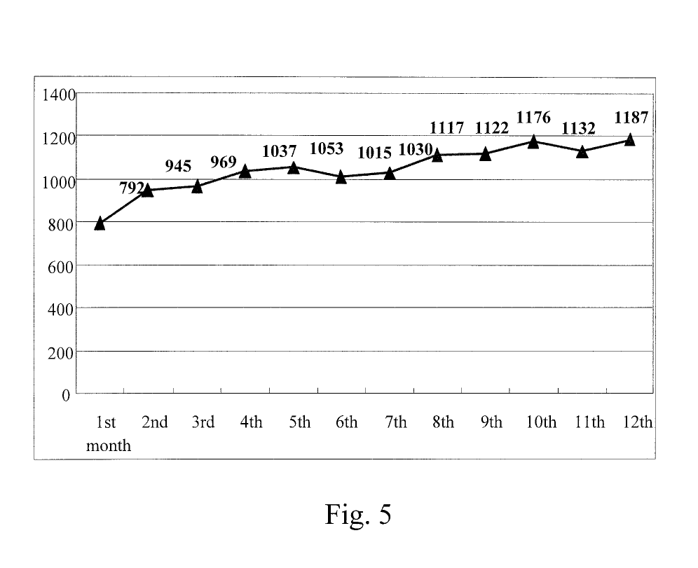

Referring to FIG. 4, a run chart shows ratios of all the manufacturing steps to the bottleneck equipment in a factory. The monitoring system according to the present invention has been confidentially tested in a factory for around twelve months by the supervisor to test and improve the monitoring system. The vertical coordinate of FIG. 4 shows ratios of all the manufacturing steps to the bottleneck equipment, for example, the photo scanner. The tendency is that the manufacturing steps moving in the whole factory are increased day by day. Also refer to FIG. 5, a run chart shows ratios of all manufacturing stages to the bottleneck equipment in the factory. The tendency is that the stages moving in the whole factory are also increased.

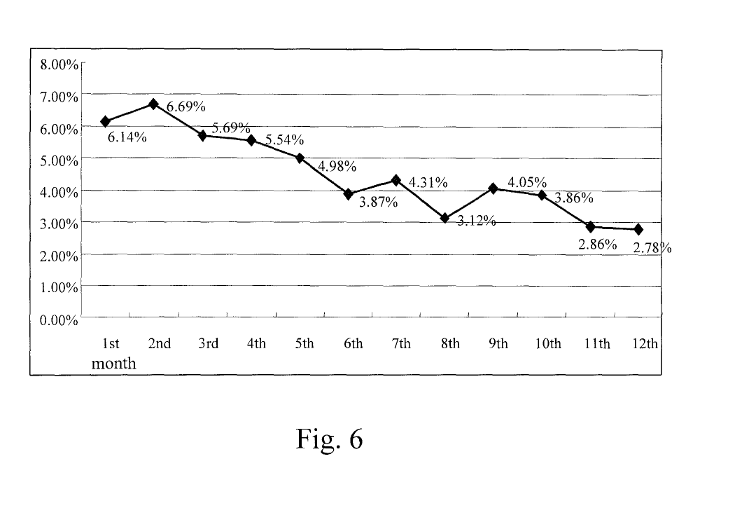

Referring to FIG. 6, a run chart shows rework ratios of the factory utilizing the monitoring system for manufacturing semiconductor wafers according to the present application. In the twelve months, the rework ratios of the whole factory decreased while utilizing the monitoring system for manufacturing semiconductor wafers according to the present invention in the factory.

With the foregoing actual production test and verification, the monitoring system for manufacturing semiconductor wafers can assist the supervisor to control the manufacturing processes while manufacturing semiconductor devices. In addition, with the composite monitoring pictures, the supervisor can easily to determine the bottleneck in the manufacturing processes, improve the production efficiency and the yield rate of manufacturing the semiconductor wafers, and further reduce the rework ratio thereof.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A monitoring system for manufacturing semiconductor wafers, comprising:
a first monitoring picture with a first coordinate and a second coordinate perpendicular to the first coordinate, wherein the first coordinate is a time coordinate and the second coordinate is a change record;
a second monitoring picture with a third coordinate and a fourth coordinate perpendicular to the third coordinate, wherein the third coordinate is also a time coordinate and parallel to the first coordinate, and the fourth coordinate shows block descriptions thereon;
a plurality of bars illustrated on the first monitoring picture, wherein each of the bars represents a working time of one wafer lot processed in a manufacturing equipment, and one end of the bar is a starting manufacture time and the other end of the bar is an ending manufacture time of the wafer lot processed in the manufacturing equipment; and
a plurality of time blocks illustrated on the second monitoring picture, wherein each of the time blocks represents an event status of the manufacturing equipment, and one end of the time block is a starting time of the event status of the manufacturing equipment and the other end of the time block is an ending time of the event status of the manufacturing equipment.

2. The monitoring system for manufacturing semiconductor wafers of claim 1, wherein the change record is a photo mask change record.

3. The monitoring system for manufacturing semiconductor wafers of claim 2, wherein the photo mask change record is the serial numbers of photo mask used in the manufacturing equipment.

4. The monitoring system for manufacturing semiconductor wafers of claim 1, wherein the change record is a mold change record.

5. The monitoring system for manufacturing semiconductor wafers of claim 1, wherein the change record is a jig change record.

6. The monitoring system for manufacturing semiconductor wafers of claim 1, wherein the time blocks comprises a setup time block.

7. The monitoring system for manufacturing semiconductor wafers of claim 1, wherein the time blocks comprises an idle time block.

8. The monitoring system for manufacturing semiconductor wafers of claim 1, wherein the time blocks comprises a monitor time block.

9. The monitoring system for manufacturing semiconductor wafers of claim 1, wherein the time blocks comprises a wait time block.

10. The monitoring system for manufacturing semiconductor wafers of claim 1, further comprising a plurality of controlling periods illustrated on the first monitoring picture.

11. The monitoring system for manufacturing semiconductor wafers of claim 10, wherein the controlling periods comprise a shift change period.

12. The monitoring system for manufacturing semiconductor wafers of claim 10, wherein the controlling periods comprise an eating period.

13. The monitoring system for manufacturing semiconductor wafers of claim 10, wherein the controlling periods comprise a night shift period.

14. A computer display for monitoring a semiconductor manufacturing equipment, the computer display comprising:
a first monitoring picture with a first coordinate and a second coordinate perpendicular to the first coordinate, wherein the first coordinate is a time coordinate and the second coordinate is a change record;
a second monitoring picture with a third coordinate and a fourth coordinate perpendicular to the third coordinate, wherein the third coordinate is also a time coordinate and parallel to the first coordinate, and the fourth coordinate shows block descriptions thereon;
a plurality of bars illustrated on the first monitoring picture, wherein each of the bars represents a working time of one wafer lot processed in the semiconductor manufacturing equipment, and one end of the bar is a starting manufacture time and the other end of the bar is an ending manufacture time of the wafer lot processed in the semiconductor manufacturing equipment; and
a plurality of time blocks illustrated on the second monitoring picture, wherein each of the time blocks represents an event status of the semiconductor manufacturing equipment, and one end of the time block is a starting time of the semiconductor manufacturing equipment and the other end of the time block is an ending time of the event status of the semiconductor manufacturing equipment.

15. The computer display for monitoring a semiconductor manufacturing equipment of claim 14, wherein the change record is a photo mask change record.

16. The computer display for monitoring a semiconductor manufacturing equipment of claim 15, wherein the photo mask change record is serial numbers of photo mask used in the semiconductor manufacturing equipment.

17. The computer display for monitoring a semiconductor manufacturing equipment of claim 14, wherein the change record is a mold change record or a jig change record.

18. The computer display for monitoring a semiconductor manufacturing equipment of claim 14, wherein the time blocks are selected from the group consisting of a setup time block, an idle time block, a monitor time block and a wait time block.

19. The computer display for monitoring a semiconductor manufacturing equipment of claim 14, further comprising a plurality of controlling periods illustrated on the first monitoring picture.

20. The computer display for monitoring a semiconductor manufacturing equipment of claim 19, wherein the controlling periods are selected from the group consisting of a shift change period, an eating period and a night shift period.
